(19) United States
(12) Patent Application Publication
(10) Pub. No.: US 2009/0180639 A1
(43) Pub. Date: Jul. 16, 2009

(54) MEDIA PLAYER SYSTEM, MEDIA PLAYER, EARPHONE, AND METHOD THEREOF

(75) Inventors: LUNG DAI, Tu-Cheng (TW); WANG-CHANG DUAN, Shenzhen City (CN); BANG-SHENG ZUO, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/136,005

(22) Filed: Jun. 9, 2008

(30) Foreign Application Priority Data
Jan. 14, 2008 (CN) 200810300086.4

(51) Int. Cl. H04R 1/10

(52) U.S. Cl. 381/74

(57) ABSTRACT

A media player system includes a media player and an earphone. The media player is used for outputting audio signals to the earphone. The earphone includes an earpiece and a sensor. The sensor is used for detecting whether the earpiece is in the ear. The sensor outputs second predetermined signals to the media player when the earpiece is not in the ear, and the media player stops outputting the audio signals to the earpiece in response to the second predetermined signals.

### BACKGROUND

1. Field of the Invention

The present invention generally relates to media player systems, and particularly to a media player associated with a media player system and an earphone, and a method thereof.

2. Description of Related Art

Generally, media players such as a moving picture experts group audio layer III (MP3) players include an earphone. If the user of the earphone temporarily removes the earphone from his or her ear, sounds are still outputted, thereby wasting power.

Therefore, a media player system for conserving power is desired.

### SUMMARY

Accordingly, a media player system is provided. The media player system includes a media player and an earphone. The media player is used for outputting audio signals to the earphone. The earphone includes an earpiece and a sensor associated with the earpiece. The sensor is used for detecting whether the earpiece is in the ear or not in the ear. The sensor outputs idle signals to the media player when the earpiece is not in the ear. The media player stops outputting the audio signals to the earpiece in response to the idle signals.

Other advantages and novel features will become more apparent from the following detailed description of exemplary embodiment when taken in conjunction with the accompanying drawings.

### BRIEF DESCRIPTION OF THE DRAWINGS

FIG. 1 is a schematic view illustrating a general construction of a media player system associated with an earphone according to an exemplary embodiment.

FIG. 2 is a functional block diagram of the media player system associated with the earphone.

FIG. 3 is a flowchart showing an operational process of the media player system associated with an earphone.

### DETAILED DESCRIPTION

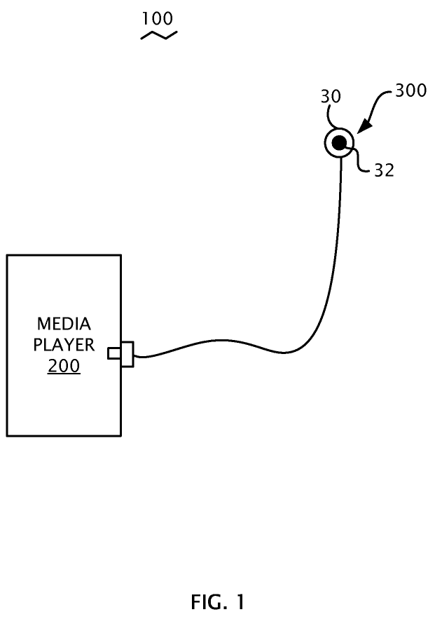

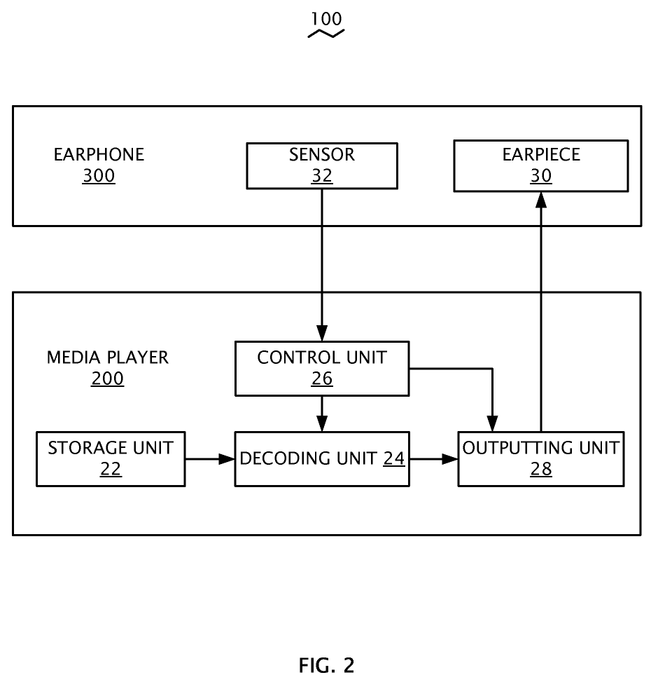

Referring to FIG. 1 and FIG. 2, a media player system 100 in accordance with an exemplary embodiment is illustrated. The media player system 100 includes a media player 200 and an earphone 300 electrically connected together.

The earphone 300 includes an earpiece 30 and a sensor 32. The earpiece 30 is used for receiving audio signals from the media player 200 and outputting sound waves. The sensor 32 is attached to the earpiece 30 for detecting whether the earpiece 30 is in the ear of the user.

When the earpiece 30 is in the ear, the sensor sends first predetermined signals continuously to the media player 200. The first predetermined signals signify that the earpiece 30 is in the ear. The media player 200 outputs audio signals to the earpiece 30 when receiving the first predetermined signals. When the earpiece 30 is not in the ear, the sensor 32 sends second predetermined signals to the media player 200. The second predetermined signals signify that the earpiece 30 is not in the ear. The media player 200 stops outputting audio signals to the earpiece 30 when receiving the second predetermined signals. Thus, conserving power.

More specifically, the media player 200 includes a storage unit 22, a decoding unit 24, a control unit 26, and an outputting unit 28.

The storage unit 22 is electrically connected to the decoding unit 24. The storage unit 22 is configured for storing audio files readable by the decoding unit 24.

The decoding unit 24 is electrically connected to the storage unit 22, the control unit 26, and the outputting unit 28. The decoding unit 24 is configured for decoding audio files in the storage unit 22, yielding audio signals, and sending the audio signals to the outputting unit 28.

The control unit 26 is electrically connected to the sensor 32, the decoding unit 24, and the outputting unit 28. The control unit 26 is configured for receiving the first predetermined signals and the second predetermined signals sent from the sensor 32. The control unit 26 is also configured for outputting decoding enable signals and decoding disable signals to the decoding unit 24, based on the first predetermined signals and the second predetermined signals respectively.

The outputting unit 28 is electrically connected to the decoding unit 24, the control unit 26, and the earpiece 30. The outputting unit 28 is configured for receiving the audio signals sent from the decoding unit 24, amplifying the audio signals, and outputting amplified audio signals to the earpiece 30.

Hereinafter, an operation of the media player system 100 will be described in detail.

When the earpiece 30 is in the ear, the sensor 32 produces first predetermined signals. The first predetermined signals are sent to the control unit 26. The control unit 26 outputs decoding enable signals to the decoding unit 24 in response to the first predetermined signals. The decoding unit 24 performs decoding actions on the audio files read from the storage unit 22 in response to the decoding enable signals. As such, audio signals are generated from the decoding unit 24 and are transmitted to the outputting unit 28.

The outputting unit 28 receives the audio signals transmitted from the decoding unit 24 and amplifies the audio signals to yield the amplified audio signals. The amplified audio signals are outputted to the earpiece 30. The earpiece 30 converts the amplified audio signals to sounds.

When the earpiece 30 is removed from the ear, second predetermined signals are generated and transmitted by the sensor 32 to the control unit 26. The control unit 26 outputs the decoding disable signals to the decoding unit 24 in response to the second predetermined signals. The decoding unit 24 stops decoding the audio files in response to the decoding disable signals, thereby the audio signals are not outputted to the outputting unit 28. As a result, the earpiece 30 does not output sounds.

As described above, when the earpiece 30 detects that it is not in the ear, the media player 200 does not output audio signals to the earpiece 30. Thereby, conserving power.

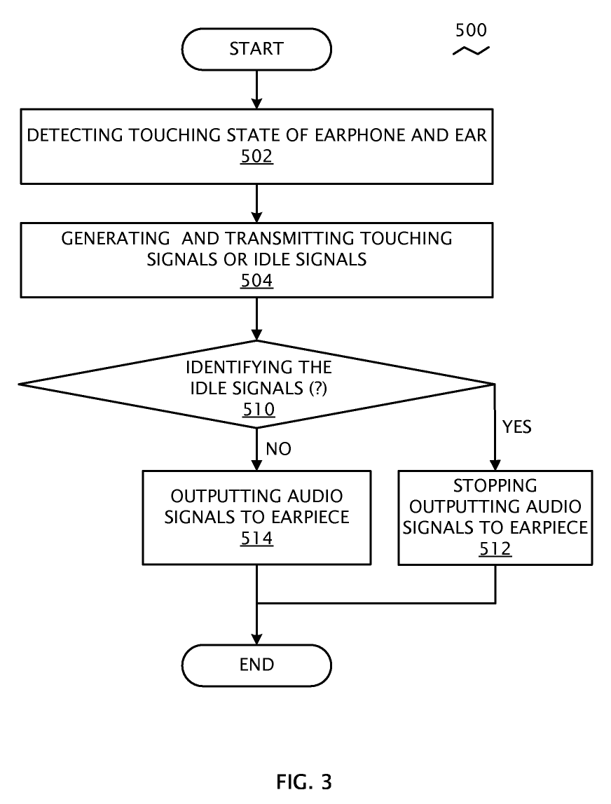

Referring to FIG. 3, a method 500 for operating the media player system 100 as described above is illustrated. The various actions in the method 500 may be performed in the order presented, or may be performed in a different order. Furthermore, in some embodiments, some actions listed in FIG. 3 may be omitted from the method 500.

At block 502, detecting whether an earpiece 30 of an earphone 300 is pressed by an ear is performed. For example, a sensor 32 is attached to the earpiece 30. The sensor 32 detects whether the earpiece 30 is in the ear.

At block 504, generating and transmitting first predetermined signals or second predetermined signals are performed. For example, the earpiece 30 together with the sensor 32 is plugged into the ear. The first predetermined signals are generated and transmitted by the sensor 30 to the media player 200. When the earpiece 30 together with the sensor 32 is taken out from the ear, second predetermined signals are generated and transmitted by the sensor 30 to the media player 200.

At block 506, identifying the first predetermined signals and the second predetermined signals is performed. For example, the sensor 32 may be a capacitive type sensor. When the earpiece 30 together with the sensor 32 is pressed with the ear, a voltage, e.g., 0.3 volts, may be generated and transmitted from the sensor 32 to the media player 200. The first predetermined signals are identified. When earpiece 30 together with the sensor 32 is removed from the ear, a voltage, e.g., 0.01 volts, may be generated and transmitted from the sensor 32 to the media player 200. The media player 200 receives pulse signals changing from 0.3 volts to 0.01 volts. Therefore, the second predetermined signals are identified by the pulse signals.

At block 512, outputting audio signals to the earpiece upon determination that the first predetermined signals generated from the sensor are identified.

At block 514, stop outputting audio signals to the earpiece upon determination that second predetermined signals generated from the sensor are identified. For example, the control unit 26 outputs decoding disable signals to the decoding unit 24 in response to the second predetermined signals. The decoding unit 24 does not output audio signals to the earpiece 30.

As described above, the method 500 for operating the media player system 100 includes actions of detecting whether the earpiece is not in the ear. When the earpiece is removed, the media player of the media player system does not output audio signals to the earpiece. Thereby, power is conserved.

The control unit 26 may output an outputting disable signal to the outputting unit in response to the idled signal sent from the sensor 32, for prohibiting outputting audio signals to the earpiece 30, instead of disabling the decoding unit 24.

Alternative embodiments will become apparent to those skilled in the art to which the present invention pertains without departing from its spirit and scope.

The media player may be a mobile phone. The media player may not have a storage unit. As such, audio files may be transmitted from external devices such as storage devices of an on-line music store to the media player for further decoding.

The media player 200 may further include other functional blocks such as a display unit for displaying a graphical user interface (GUI) that may be selected by a keypad arranged with the media player 200 to control overall operations of the media player 200.

The earphone 300 may be wirelessly coupled to the media player 200 via wireless communication technology such as Bluetooth®. The sensor 32 may be other type, such as resistive type, or piezoelectric type.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A media player system comprising:
a media player for decoding audio files and outputting audio signals decoding from the audio files; and
an earphone associated with the media player, comprising:
an earpiece for receiving the audio signals and converting the audio signals to sound waves; and
a sensor attached with the earpiece for detecting whether the earpiece is in an ear of a user, the sensor outputting first predetermined signals to the media player when the earpiece is detected not in the ear, and the media player outputting the audio signals to the earpiece in response to the first predetermined signals, the first sensor outputting second predetermined signals to the media player when the earpiece is detected not in the ear, and the media player stops outputting the audio signals to the earpiece in response to the second predetermined signals.

2. The media player system of claim 1, wherein the earphone is wirelessly coupled to the media player in accordance with Bluetooth communication technology.

3. The media player system of claim 1, wherein the sensor is a capacitive sensor, a resistive sensor, or a piezoelectric sensor.

4. A media player coupled with an earphone for decoding audio files stored therein or transmitted from external devices and outputting audio signals decoded from the audio files to the earphone, the media player comprising:
a control unit coupled to the earphone for receiving first predetermined signals and second predetermined signals from a sensor attached with the earphone for indicating the earphone is in or out of an ear respectively, the control unit outputting decoding enable signals and decoding disable signals in response to the first predetermined signals and the second predetermined signals respectively;
a decoding unit connected the control unit for decoding the audio files in response to the decoding enable signals and generating audio signals decoded from the audio files, disabling decoding the audio files in response to the decoding disable signals; and
an outputting unit connected to the decoding unit for outputting audio signals to the earphone corresponding to the first predetermined signals, and stop outputting the audio signals to the earphone corresponding to the second predetermined signals.

5. The media player of claim 4, wherein the media player is wirelessly coupled to the earphone in accordance with Bluetooth communication technology.

6. The media player of claim 4, wherein the sensor is a capacitive sensor, a resistive sensor, or a piezoelectric sensor.

7. An earphone coupled to a media player for receiving audio signals decoded by the media player, the earphone comprising:
an earpiece for receiving audio signals and converting the audio signals to sound waves; and
a sensor attached to the earpiece for detecting a contacting status between the earpiece and an ear;
wherein the sensor sending second predetermined signals to the media player when the earpiece is detected not in the ear, and the audio signals are not received by the earpiece corresponding to the second predetermined signals.

8. The earphone of claim 7, wherein the sensor sends first predetermined signals to the media player when the earpiece is detected not in the ear, and the audio signals are received by the earpiece corresponding to the first predetermined signals.

9. The earphone of claim 7, wherein the earphone is wirelessly coupled to the media player in accordance with Bluetooth communication technology.

10. The earphone of claim 7, wherein the sensor is a capacitive sensor, a resistive sensor, or a piezoelectric sensor.
